(19) United States
(12) Patent Application Publication
(10) Pub. No.: US 2013/0314187 A1
(43) Pub. Date: Nov. 28, 2013

(54) Fault Current Limiter

(71) Applicant: Frank Darmann, Leumeah (AU)

(72) Inventor: Frank Darmann, Leumeah (AU)

(21) Appl. No.: 13/497,480

(22) PCT Filed: Sep. 27, 2010
(86) PCT No.: PCT/AU2010/001265

§ 371 Date: Jul. 26, 2012

(30) Foreign Application Priority Data
Sep. 25, 2009 (GB) 0916878.2

(51) Int. Cl. H01F 38/00

(52) U.S. Cl. CPC H01F 38/00
USPC 336/90; 336/221; 336/220; 336/170

(57) ABSTRACT

A three phase fault current limiter (FCL 6) has three spaced apart input terminals (7) for electrically connecting to respective terminals (5) of a transformer (2). Three output terminals (8) electrically connect FCL (6) with a load circuit (9) which draws load current I_{LOAD}. FCL (6) includes a multi-post magnetically saturable core (11) and three AC coils (12, 13 and 14) for electrically connecting terminals (7) to respective terminals (8). Coils (12, 13 and 14) allow I_{LOAD} to flow from a power station (4) to circuit (9). Coils (12, 13 and 14) include respective pairs of series connected high voltage cables (15a and 15b, 16a and 16b and 17a and 17b) wound about core (11). Two generally triangular spaced apart DC coils (19, 20) induce a magnetic field in at least that portion of core (11) about which the cables are wound. The field magnetically biases core (11) such that coils (12, 13 and 14) individually move from a low impedance state to a high impedance state in response to I_{LOAD} approaching I_{MAX}.

### FIELD OF THE INVENTION

The present invention relates to a fault current limiter and a method of limiting fault current.

### BACKGROUND

Any discussion of the prior art throughout the specification should in no way be considered as an admission that such prior art is widely known or forms part of common general knowledge in the field.

The peak loads for mains electrical distribution systems (EDS) are increasingly approaching, and often exceeding, even if only for short periods, the supply capacity for which the EDS was designed. Moreover, peak loads of this nature are occurring increasingly due to the rising demand for electrical energy from the EDS. This is contributed to by, for example, the increased use of electronic and electrical appliances within business and government facilities and residences. Other contributing factors include increasing population sizes that are being served by an existing EDS and increasing population densities in urban areas.

An EDS typically includes one or more electrical substations having transformers for converting the voltage from a high transmission voltage to a lower transmission voltage for subsequent distribution to a local load. This load, in turn, typically includes a plurality of further step down transformers for providing the main supply voltage to residences, businesses and other sites. In other words, the loads supplied by respective transformers in the substations are defined by the residences or facilities downstream of the relevant transformer. The load, as a whole, draws a total load current that is supplied by the respective transformer.

Each transformer is rated to carry a predetermined maximum current and should that current be exceeded due to the load current being greater than a predetermined maximum current, even if only for a short time, the protection circuitry and switchgear for the substation should operate to isolate the associated transformers from the load. While in the event of a dangerous fault this is acceptable, in cases of a transient peak the isolation of the transformer from the load is inconvenient for both the operator of the transformers and for the consumers that are supplied electrical energy via the transformers.

In an attempt to enhance the reliability of supply in light of the above-mentioned increase in load demand, there has been a trend to greater grid inter-connectivity, the inclusion of additional base and peak generation capacity, and an increase in embedded generation at lower voltages from a variety of sources such as wind farms. However, all these factors lower the source impedance and thereby increase the fault current at substation equipment such as transformers and switchgear. Often, the fault current rating of this substation equipment is insufficient to meet the new demands and the substation operator is faced one of a number of options including: replacing the equipment with plant that is rated for higher fault currents; building a new substation; and/or managing the fault current level by operating the substation in a “split bus” mode. The first two options, of replacing plant and building new substations, are costly, especially in urban areas. The third option, of operating a substation in “split bus” mode reduces the reliability of the supply because a failure of a single transformer can leave large urban areas blacked out, or cause a disturbance which results in industries losing sensitive loads.

To address these problems use has been made more recently of a fault current limiter (FCL) immediately downstream of a transformer to ensure that the maximum load current does not exceed the predetermined maximum current. This is done to protect the transformer for those typically short periods where over-current conditions would have otherwise existed, while also allowing continuity of supply to the downstream load circuit. Such an FCL is responsive to the load current for introducing a series impedance to limit the current drawn by the load to a predetermined maximum. When the current is being limited by the FCL there will be transient voltage drop in the EDS downstream of the transformer. For momentary overloads, this is often an acceptable compromise to complete isolation of the load from the transformer.

Use has been made of saturated core FCLs, on the one hand, and other types of FCLs which use reactors, on the other hand, to limit fault currents. These devices typically require AC coils having in the order of 10 to 100 turns and which have basic electrostatic insulation to ground and phase-to-phase rated at the system voltage. In addition, this insulation must be suitable to meet the various transient electrostatic conditions according to the relevant IEEE C57 standards such as chopped wave and lighting impulse and other tests such as dielectric tests. The choice now often favoured by manufacturers for providing the insulation for the high voltage coil or coils is to use copper conductors which are thinly insulated by a covering of paper, polyimide, powder coating, Nomex® fabric, or other electrical insulation material. It will be appreciated that this insulation provides the turn-to-turn insulation for the coils and is advantageous as it is relatively thin. Multiple strands “in hand” of these thinly insulated copper conductors are then wound to form a coil with the required number of turns. To ensure there is sufficient insulation in the event of a fault condition, the entire coil is then immersed in a dielectric fluid or gas to provide the required bulk electrostatic insulation to ground and to the other phases. For saturated core FCLs where use is made of a pair of half-phase coils for each phase, the dielectric fluid also contributes to the required insulation between those half-phase coils.

Typical dielectric fluids employed are air and mineral oil for system voltages below 33 kV, silicone oil for 33 kV to 69 kV, and mineral oil or high pressure SF6 combined with shielding barriers for higher voltages.

Another insulation option is to form solid insulation over the coil. This is done by, for example, heat curing a liquid epoxy to the coil. This technique is typically only employed in exceptional circumstances because of the overall cost and the difficulty of forming such insulation without voids. Voids between the active conductor and the electrical insulation are particularly problematic, for they attract high electrostatic voltages and lead to partial discharges, tracking, and eventual failure of the insulation and the coil. Hence, forming a solid insulation over a coil to provide the bulk insulation to ground or phase-to-phase is usually limited to the 33 kV devices and only in special circumstances where a liquid dielectric cannot be employed due to fire hazard.

The use of FCLs is relatively recent and often requires the FCL to be installed in an existing substation immediately adjacent to the relevant transformer. This retrofit requirement places considerable packaging constraints upon the design of an FCL and limits the application of FCLs. In practice, it has been found that the footprint of the FCL is more often the critical factor in allowing an FCL to be installed within a given substation. However, in other substations other critical factors include the height of the FCL or a combination of height and footprint.

### SUMMARY

It is an object of the present invention, at least in one embodiment, to overcome or ameliorate at least one of the disadvantages of the prior art, or to provide a useful alternative.

According to a first aspect of the invention there is provided a fault current limiter including:

an input terminal for electrically connecting to a power source that provides a load current;

an output terminal for electrically connecting to a load circuit that draws the load current;

a magnetically saturable core;

an AC coil for electrically connecting the input and the output terminals and for allowing the load current to flow from the source to the load, wherein the coil includes a high voltage cable wound about a portion of the core; and

a DC coil for inducing a magnetic field in at least the portion of the core wherein the field magnetically biases the core such that the AC coil moves from a low impedance state to a high impedance state in response to one or more characteristics of the load current.

In an embodiment, the load current includes multiple phases and the current limiter includes a plurality of input terminals, output terminals and AC coils for each phase, wherein each coil includes a respective high voltage cable wound about the core.

In an embodiment, the core includes a plurality of posts about which respective cables are wound.

In an embodiment, the posts are spaced apart such that the cables associated with adjacent posts are juxtaposed.

In an embodiment, the cables associated with adjacent posts abut.

In an embodiment, the cable is wound about the core in a single layer.

In an embodiment, the cable is wound about the core in no more than two layers.

In an embodiment, the fault current limiter has an open core configuration.

In an embodiment, the fault current limiter has a closed core configuration.

In an embodiment, the AC coil includes two AC cables having respective input ends and output ends, the two AC cables being co-wound about the core and the input ends being electrically connected and the output ends being electrically connected.

In an embodiment, one of the one or more characteristics includes the amplitude of the load current.

In an embodiment, the field magnetically biases the core such that the AC coil moves toward either the low impedance state or the high impedance state to limit the load current to no more than a predetermined current limit.

In an embodiment, the portion of the core comprises substantially all of the core. In other embodiments, the portion of the core is much less than all of the core.

In an embodiment, the fault current limiter includes a thermal regulator for managing the temperature of at least the AC coil. In an embodiment, the thermal regulator uses a heat exchange fluid such as air, other gases, or oil.

In a second aspect of the invention there is provided a fault current limiter for electrically connecting an AC source to a load, the fault current limiter including at least one AC coil for carrying a load current provided by the source to the load, wherein the coil includes a high voltage cable.

In an embodiment, the coil includes a plurality of windings, and the cable defines at least one of those windings.

In an embodiment, the cable defines all the windings.

In an embodiment, the cable is segmented.

In an embodiment, the cable is continuous.

In an embodiment, the fault current limiter includes a plurality of AC coils including respective high voltage cables.

In an embodiment, the fault current limiter includes a magnetically saturable core about which the cable or cables are wound.

In an embodiment, the core includes a plurality of posts about which respective cables are wound.

In an embodiment, the posts are substantially parallel.

In an embodiment, the posts are substantially coextensive.

In an embodiment, wherein the posts are spaced apart.

In an embodiment, at least two posts are spaced apart from each other such that the respective cables are abutted or closely adjacent to each other.

In an embodiment, the AC coil includes at least two AC cables.

In an embodiment, the two AC cables are wound in parallel.

In an embodiment, the two AC cables each include an input end and an output end, wherein the input ends are electrically connected to each other and the output ends are electrically connected to each other.

In an embodiment, the two AC cables are mechanically connected to each other at a plurality of locations intermediate the input and output ends.

In an embodiment, the two AC cables are substantially coextensive.

According to a third aspect of the invention there is provided an electrical distribution system including:
a transformer for providing a predetermined maximum operating current at a predetermined operating voltage, the transformer including: first input terminals for connecting with an electrical power source that provides a first operating voltage; and first output terminals that provide a load current at the predetermined operating voltage;
a fault current limiter having:
   (a) second input terminals for electrically connecting to the first output terminals;
   (b) second output terminals for electrically connecting with a load circuit that draws the load current;
   (c) a magnetically saturable core;
   (d) a plurality of AC coils for electrically connecting second input terminals and second output terminals and through which the load current flows to the load, wherein the coils each include a respective high voltage cable wound about the core; and
   (e) at least one DC coil for inducing a magnetic field in at least that portion of the core about which the cables are wound, wherein the field magnetically biases the core such that the AC coils move from a low impedance state to a high impedance state in response to the load current approaching the predetermined maximum current.

According to a fourth aspect of the invention there is provided a former for a coil, the former including:

a longitudinally extending body about which the coil is wound along a predetermined path; and

a retention system for maintaining the coil along the path.

In an embodiment, the body is tubular and receives a core.

In an embodiment, the retention system is secured to the body.

In an embodiment, the retention system is at least in part integrally formed with the body.

According to a fifth aspect of the invention there is provided a fault current limiter including:

an input terminal for electrically connecting to a power source that provides a load current;

an output terminal for electrically connecting with a load circuit that draws the load current;

a magnetically saturable core;

an AC coil for electrically connecting the input and the output terminals and for allowing the load current to flow from the source to the load, wherein the coil includes a high voltage cable wound about a portion of the core; and

a DC coil for inducing a magnetic field in at least the portion of the core, wherein the field magnetically biases the core such that the impedance of the AC coil regulates one or more characteristics of the load current.

In an embodiment, one of the one or more characteristics includes the amplitude of the load current. For example, the field magnetically biases the core such that the impedance of the AC coil contains the amplitude of the load current to no more than a predetermined current limit. That is, the impedance of the AC coil varies with time to limit the load current to a maximum possible value.

According to a sixth aspect of the invention there is provided a method of limiting fault current, the method including the steps of:

electrically connecting an input terminal to a power source that provides a load current;

electrically connecting an output terminal to a load circuit that draws the load current;

providing a magnetically saturable core;

electrically connecting an AC coil to the input and the output terminals for allowing the load current to flow from the source to the load, wherein the coil includes a high voltage cable wound about a portion of the core; and

providing a DC coil for inducing a magnetic field in at least the portion of the core, wherein the field magnetically biases the core such that the AC coil moves from a low impedance state to a high impedance state in response to one or more characteristics of the load current.

According to a seventh aspect of the invention there is provided a method of limiting a load current provided by an AC source to a load, the method including the step of providing at least one AC coil for carrying the load current from the source to the load, wherein the coil includes a high voltage cable.

According to an eighth aspect of the invention there is provided a method of distributing electrical energy, the method including the steps of:
providing a transformer with a predetermined maximum operating current at a predetermined operating voltage, the transformer including: first input terminals for connecting with an electrical power source that provides a first operating voltage; and first output terminals that provide a load current at the predetermined operating voltage;
providing a fault current limiter having:
   (a) second input terminals for electrically connecting to the first output terminals;
   (b) second output terminals for electrically connecting with a load circuit that draws the load current;
   (c) a magnetically saturable core;
   (d) a plurality of AC coils for electrically connecting second input terminals and second output terminals and through which the load current flows to the load, wherein the coils each includes a high voltage cable wound about the core; and
   (e) at least one DC coil for inducing a magnetic field in at least that portion of the core about which the cables are wound, wherein the field magnetically biases the core such that the AC coils move from a low impedance state to a high impedance state in response to the load current approaching the predetermined maximum current.

According to a ninth aspect of the invention there is provided a method for forming a coil for a fault current limiter, the method including the steps of:

winding a high voltage cable about a longitudinally extending body, wherein the cable is wound along a predetermined path; and

maintaining the coil along the path with a retention system.

According to a tenth aspect of the invention there is provided a method of limiting fault current, the method including the step of:

electrically connecting an input terminal to a power source that provides a load current;

electrically connecting an output terminal to a load circuit that draws the load current;

providing a magnetically saturable core;

electrically connecting an AC coil to the input and the output terminals and for allowing the load current to flow from the source to the load, wherein the coil includes a high voltage cable wound about a portion of the core; and

providing a DC coil for inducing a magnetic field in at least the portion of the core, wherein the field magnetically biases the core such that the impedance of the AC coil regulates one or more characteristics of the load current.

According to an eleventh aspect of the invention there is provided a fault current limiter including:

a housing;

an input terminal being coupled to the housing for electrically connecting to a power source that provides a load current;

an output terminal being coupled to the housing and spaced longitudinally from the input terminal for electrically connecting with a load circuit that draws the load current; and

a current limiting element that is received within the housing for carrying the load current between the input terminal and the output terminal, the current element including at least one AC coil wound about a coil axis that extends longitudinally; and is responsive to one or more characteristics of the load current for moving from a low impedance state to a high impedance state;

wherein said input and output terminals are located at opposed ends of said housing and are interconnected to the at least one AC coil.

In an embodiment the input and output terminals are located at the top of the ends of the housing.

In an embodiment the AC coil carries the load current and the current limiting element includes:

a magnetically saturable core about which the AC coil is wound; and

at least one DC coil for inducing a magnetic field in at least that portion of the core about which the AC coil is wound, wherein the field magnetically biases the core such that the AC coil moves from the low impedance state to the high impedance state in response to the load current reaching a predetermined threshold.

In an embodiment the fault current limiter as claimed in claim 2 includes at least two DC coils being longitudinally spaced apart from each other.

In an embodiment the load current is a multiphase current and the fault current limiter includes: a plurality of pairs of longitudinally spaced input and output terminals, one pair for each phase of the current; and a corresponding plurality of AC coils extending between the input and output terminals in the respective pairs.

In an embodiment the housing is generally cylindrical and has a housing axis.

In an embodiment the housing axis extends longitudinally.

According to a twelfth aspect of the invention there is provided a fault current limiter including:

a housing extending between two longitudinally spaced apart ends;

an input terminal being coupled to the housing at or adjacent to one of the ends for electrically connecting to a power source that provides a load current;

an output terminal being coupled to the housing at or adjacent to the other of the ends for electrically connecting with a load circuit that draws the load current; and

a current limiting element that is received within the housing for carrying the load current between the input terminal and the output terminal, wherein the element: includes at least one AC coil wound about a coil axis that extends longitudinally; and is responsive to one or more characteristics of the load current for moving from a low impedance state to a high impedance state.

In an embodiment the AC coil is disposed between the ends.

In an embodiment the AC coil is disposed between the terminals.

In an embodiment the housing is substantially cylindrical and has a housing axis extending longitudinally.

According to a thirteenth aspect of the invention there is provided an electrical distribution system for extending between a power source and an electrical load that draws a load current, the system including:
a transformer for electrically connecting with the power source for providing the load current; and
a fault current limiter for electrically connecting with the transformer and carrying the load current, wherein the fault current limiter includes:
   (a) a housing;
   (b) an input terminal being coupled to the housing and electrically connected to the transformer;
   (c) an output terminal being coupled to the housing and spaced longitudinally from the input terminal for electrically connecting with the load; and
   (d) a current limiting element that is received within the housing for carrying the load current between the input terminal and the output terminal, wherein the element: includes at least one AC coil wound about a coil axis that extends longitudinally; and is responsive to one or more characteristics of the load current for moving from a low impedance state to a high impedance state, and wherein the input and output terminals are located at opposed ends of said housing and are interconnected to the at least one AC coil.

### BRIEF DESCRIPTION OF THE DRAWINGS

Embodiments of the invention will now be described, by way of example only, with reference to the accompanying drawings in which:

FIG. 1 is a schematic view of a fault current limiter (FCL) according to an embodiment of the invention disposed in an electrical distribution system (EDS);

FIG. 2 is a partially cutaway perspective view of the FCL of FIG. 1;

FIG. 3 is a partially cutaway perspective view of another FCL similar to that of FIG. 1 but including additional DC coils;

FIG. 4 is a partially cutaway top view of the FCL of FIG. 1;

FIG. 5 is a partially cutaway perspective view of a further FCL having three separate tanks;

FIG. 6 is a partially cutaway perspective view of another FCL similar to that of FIG. 5 but including additional DC coils;

FIG. 7 is a partially cutaway top view of the FCL of FIG. 6;

FIG. 8 is a partially cutaway perspective view of a further FCL having the posts arranged in an 6×1 array;

FIG. 9 is a partially cutaway perspective view of another FCL similar to that of FIG. 8 but including an additional DC coil;

FIG. 10 is a partially cutaway top view of the FCL of FIG. 9;

FIG. 11 is a partially cutaway perspective view of a further FCL having three separate horizontally extending tanks;

FIG. 12 is a partially cutaway end view of the FCL of FIG. 11;

FIG. 13 is a partially cutaway side view of one of the tanks of the FCL of FIG. 11;

FIG. 14 is a partially cutaway perspective view of a further FCL having three stacked horizontally extending tanks;

FIG. 15 is a partially cutaway end view of the FCL of FIG. 14;

FIG. 16 is a partially cutaway perspective view of a further FCL having three stacked horizontally extending tanks with four common DC coils;

FIG. 17 is a partially cutaway perspective view of a further FCL having three stacked horizontally extending tanks with two common DC coils;

FIG. 18 is a partially cutaway end view of the FCL of FIG. 17;

FIG. 19 is a partially cutaway perspective view of a further FCL having the posts disposed in separate tanks arranged in a linear array;

FIG. 20 is a partially cutaway end view of two of the tanks of FIG. 19 containing the windings associated with the same phase;

FIG. 21 is a partially cutaway side view of one of the tanks of FIG. 19;

FIG. 22 is a partially cutaway side view similar to that of FIG. 21, but of another embodiment having a ventilation system;

FIG. 23 is a is a partially cutaway perspective view of a further FCL having posts with a greater longitudinal length relative to the longitudinal length of the coil;

FIG. 24 is a partially cutaway end view of the FCL of FIG. 23;

FIG. 25 is a partially cutaway side view of one of the tanks of FIG. 23;

FIG. 26 is a partially cutaway perspective view of a single phase FCL including a cooling fluid;

FIG. 27 is a partially cutaway end view of the FCL of FIG. 26;

FIG. 28 is a partially cutaway side view of the FCL of FIG. 26;

FIG. 29 is a perspective view of a core and an associated AC coil for a fault current limiter illustrating an AC coil retention system; and

FIG. 30 is a perspective view similar to FIG. 29 but of an alternative AC coil retention system.

### DETAILED DESCRIPTION

The following description and Figures make use of reference numerals to assist the addressee understand the structure and function of the illustrated embodiments. Like reference numerals are used in different embodiments to designate features having the same or similar function and/or structure.

The drawings need to be viewed as a whole and together with the associated text in this specification. In particular, some of the drawings selectively omit features to provide greater clarity about the specific features being described. While this is done to assist the reader, it should not be taken that those features are not disclosed or are not required for the operation of the relevant embodiment.

Where use is made of the term “an embodiment” in relation to a feature, that is not to be taken as indicating there is only one embodiment in which that feature is able to be used, or that that feature is not able to be used in combination with other features not illustrated as being in the same embodiment. It will be appreciated by the skilled addressee that while some features are mutually exclusive within a single embodiment, others are able to be combined.

This patent specification is related to the specification contained with GB patent application number 0916878.2 in the name of the same applicant. The disclosure within the latter is expressly incorporated, in its entirety, into this specification by way of cross-reference. Without limitation, also incorporated by way of cross-reference into this specification are the claims included within the abovementioned GB patent application.

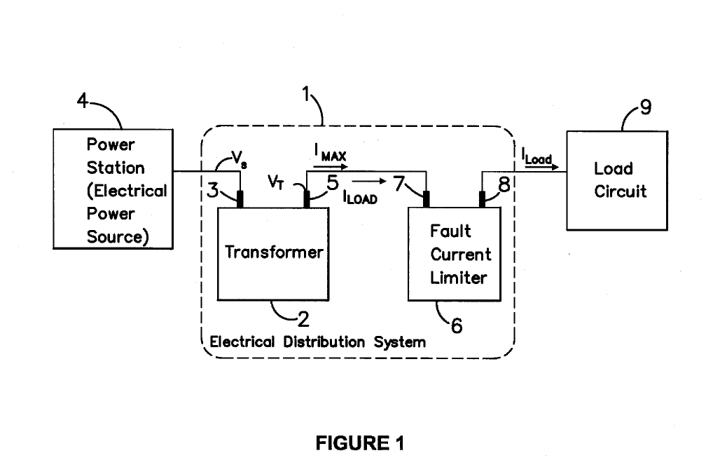

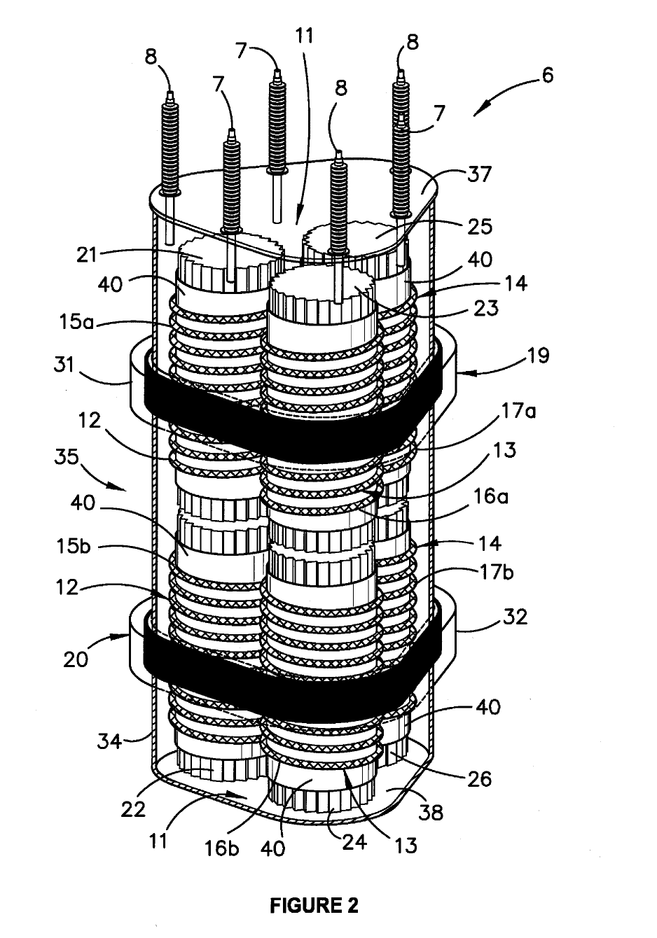

Referring to FIG. 1, there is illustrated an electrical distribution system 1 including a three phase 66/11 kV transformer 2 for providing a predetermined maximum operating current I_{MAX} at a predetermined operating voltage V_{T}. Transformer 2 includes three first input terminals 3 (only one shown) for connecting with a three phase electrical power source in the form of a coal fired power station 4. The power station provides a first operating voltage V_{S}, which at terminals 3 is 66 kV. The transformer also includes three first output terminals 5 that provide a load current I_{LOAD} at the predetermined operating voltage V_{T}, where V_{T}=11 kV. System 1 includes a three phase fault current limiter, which is referred to as FCL 6, having, as best shown in FIG. 2, three spaced apart second input terminals 7 for electrically connecting to respective terminals 5 of transformer 2. Again referring to FIG. 1, three second output terminals 8 electrically connect FCL 6 with a load circuit 9, which draws load current I_{LOAD}. FCL 6 includes, as best shown in FIG. 2, a multi-post magnetically saturable core 11 and three AC coils 12, 13 and 14 for electrically connecting terminals 7 to respective terminals 8. Coils 12, 13 and 14 allow I_{LOAD} to flow from station 4 to circuit 9. Coils 12, 13 and 14 include respective pairs of series connected high voltage cables 15a and 15b, 16a and 16b and 17a and 17b wound about core 11. Two generally triangular spaced apart DC coils 19 and 20 induce a magnetic field in at least that portion of core 11 about which the cables are wound. The field magnetically biases core 11 such that coils 12, 13 and 14 individually move from a low impedance state to a high impedance state in response to I_{LOAD} approaching I_{MAX}.

The movement of the coils from a low impedance to a high impedance state increases the impedance in the current path through which I_{LOAD} must flow. This limits I_{LOAD} as V_{S} and V_{T} are relatively tightly controlled. It will be appreciated that FCL 6 is designed such that, in use, I_{LOAD} is limited to no more than I_{MAX}. This ensures that the current carried by transformer 2 is limited which, in turn, provides overload protection for that transformer.

In other embodiments, V_{T} and V_{S} are other than 11 kV and 66 kV. Moreover, in other embodiments, station 4 is other than coal fired.

In other embodiments, use is made of a greater or lesser number of DC coils.

Core 11 includes six substantially cylindrical like posts 21, 22, 23, 24, 25 and 26 that are formed from a laminated high permeability material. In other embodiments the posts are formed from other high permeability materials. In some such embodiment, each post includes a container (not shown) having a similar form to the illustrated posts, but which contain a high permeability powder.

The posts in FIG. 2 are arranged in pairs in a stacked 3×2 array, where pairs of posts are associated with respective phases of the EDS. The respective pairs include posts 21 and 22, posts 23 and 24 and posts 25 and 26.

The posts are elongate and substantially circular in transverse cross-section. In other embodiments the posts have of other geometrical dimensions and configurations. Moreover, in some embodiments, not all posts are like.

Coil 12 is associated with one phase of the three phase supply and is defined by two sub-coils which are, in turn, defined by cables 15a and 15b. These cables are wound in a single layer about posts 21 and 22 respectively ten times, but in the opposite sense, to each define ten windings that extend along a substantially continuous and uniform helical path. Coil 13 is defined by two sub-coils which are, in turn, defined by cables 16a and 16b. These cables are wound about posts 23 and 24 respectively ten times, but in the opposite sense, to each define ten windings that extend along a substantially continuous and uniform helical path. Coil 14 is defined by two sub-coils which are, in turn, defined by cables 17a and 17b. These cables are wound about posts 25 and 26 respectively ten times, but in the opposite sense, to each define ten windings that extend along a substantially continuous and uniform helical path. The opposite sense of the windings in each pair of cables is to allow current limiting in both half-cycles of the respective phases.

In other embodiments, one or more of the pairs of cables is replaced by a single continuous cable.

In further embodiments the cables are wound about the core other than ten times.

In the above embodiment the cables define all the windings of the coils 12, 13 and 14. In some embodiments, however, less than all the windings are defined by the cables.

In some embodiments, one or more of cables 15a, 15b, 16a, 16b, 17a and 17b are wound about respective posts in two layers. However, where footprint considerations are more critical, it is more usual that only a single layer is used. Moreover, preferentially all cables are wound similarly to best support symmetrical operation between phases for FCL 6.

The cables, as shown, are wound such that adjacent windings are spaced apart. However, in other embodiments, the adjacent windings are more closely juxtaposed or, in some embodiments, abutted with each other. The cables are each secured relative to core 11 to reduce the risk of movement of the cables and the windings defined by those cables.

FCL 6 includes two longitudinally spaced apart substantially like HTS DC coils 19 and 20. The coils are housed in respective cryostatic chambers 31 and 32 for maintaining the DC coils at a temperature where they are superconductive. The DC coils are configured to induce a magnetic field that during normal operation of FCL 6 saturates at least that portion of core 11 about which the cables are wound. This magnetically biasing of the core ensures that during normal operation—that is, in the absence of a fault and where I_{LOAD}<I_{MAX}—that coils 12, 13 and 14 present a low impedance. Additionally, the bias is such that, should a fault occur or for any other reason I_{LOAD} exceeds I_{MAX}, the magnetic field generated by the coil will be sufficient to bring the respective core out of saturation. This results in the coil presenting a much higher impedance to the load current, which limits the load current.

The posts extend longitudinally along respective notional parallel axes that are equally spaced apart from each other. The spacing is such that there is a gap between windings on adjacent posts in other pairs. In other embodiments, those windings are closely juxtaposed or abutted.

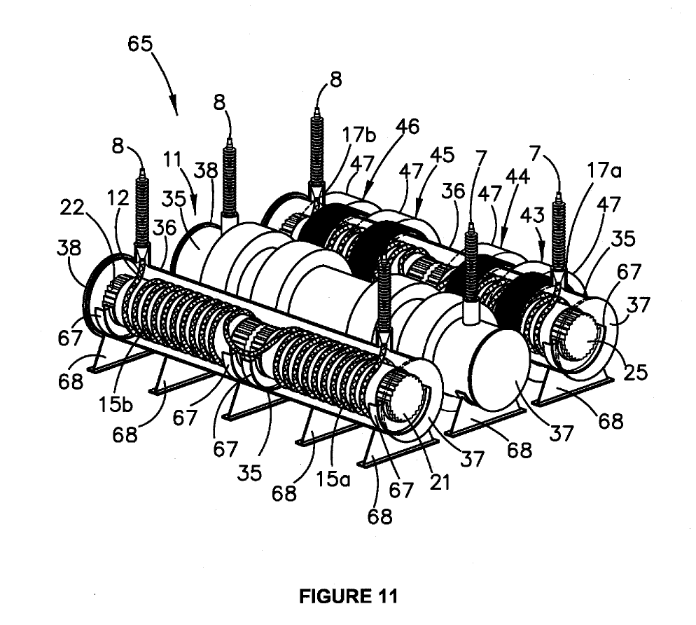

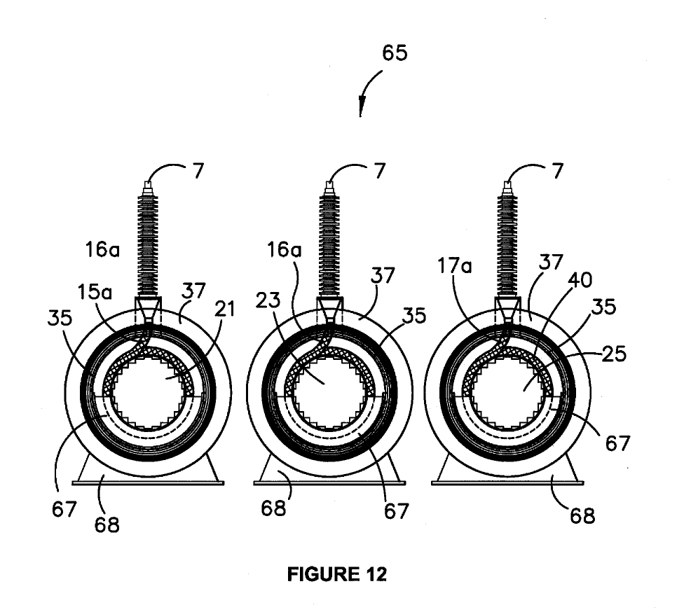

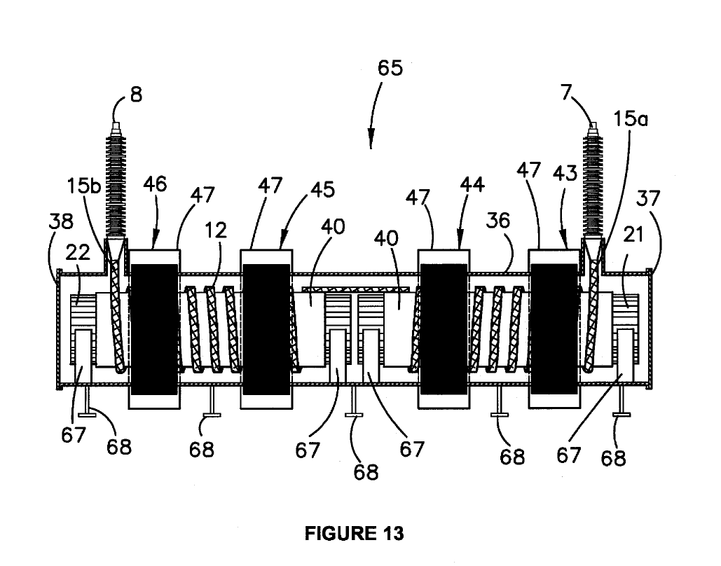

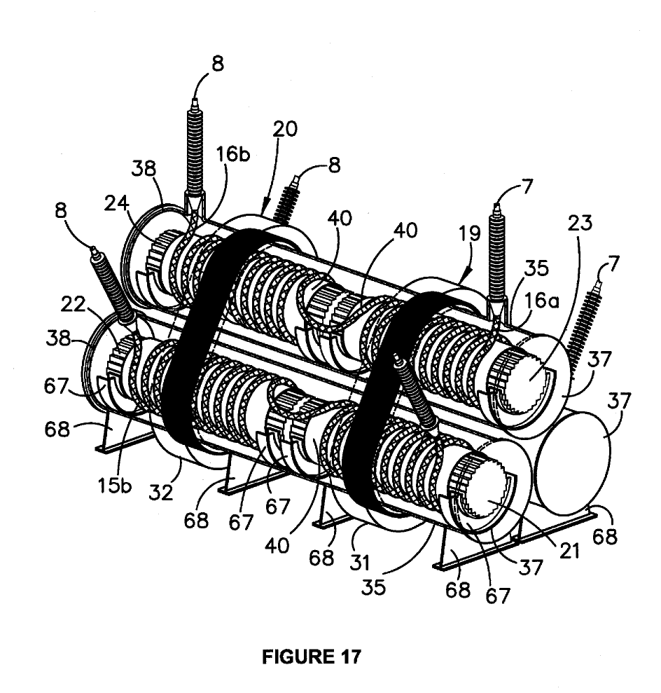

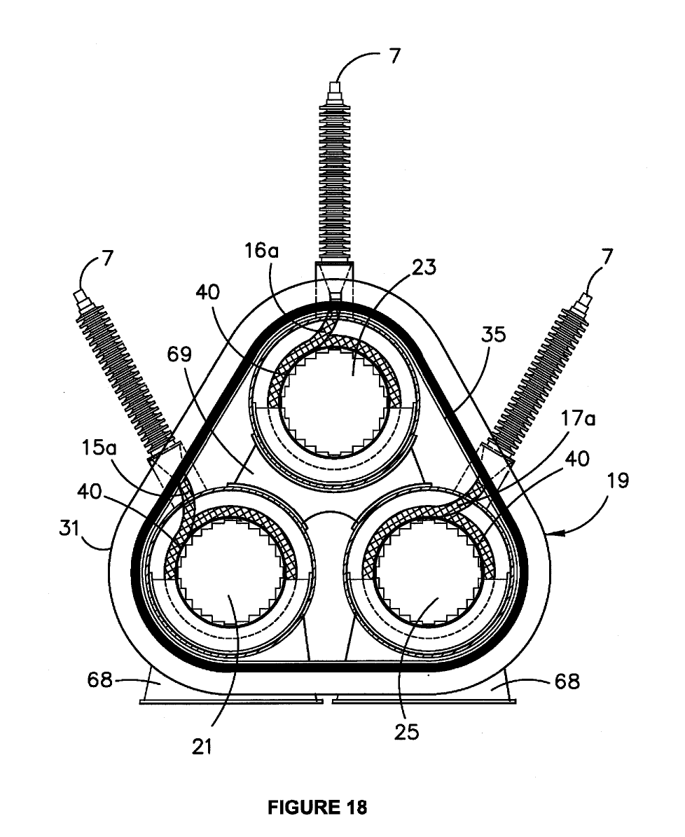

The six posts defining core 11 are contained within a thin gauge steel tank 35. Tank 35 includes an interior that is collectively defined by: a continuous tubular longitudinally extending sidewall 36 of substantially uniform transverse cross-section; and two longitudinally spaced apart and opposed end caps 37 and 38 that are fixedly connected to sidewall 36. All the posts and windings are disposed with tank 35, and terminals 7 and 8 extend outwardly from end cap 37. By way of example, cables 15a and 15b each include a fixed end and a free end, where the fixed ends are electrically connected to each other, and the free ends are electrically connected to respective terminals 7 and 8. Accordingly, cable 15b extends from the bottom of tank 35—that is, from adjacent to cap 38, and upwardly to terminal 8. In other embodiments, for example, as shown in FIGS. 11 to 16, terminals 7 and 8 extend from end caps 37 and 38 respectively. This obviates the need for cable 15b, 16b, and 17b to extend back along the post or posts to connect with the respective output terminal. Another option is provided by the embodiment of FIGS. 17 and 18, where terminals 7 and 8 extend outwardly from sidewall 36.

It will be appreciated that the terminals are disposed at the end of high voltage bushings to provide the required electrostatic clearance between the terminals and the earthed tanks 35.

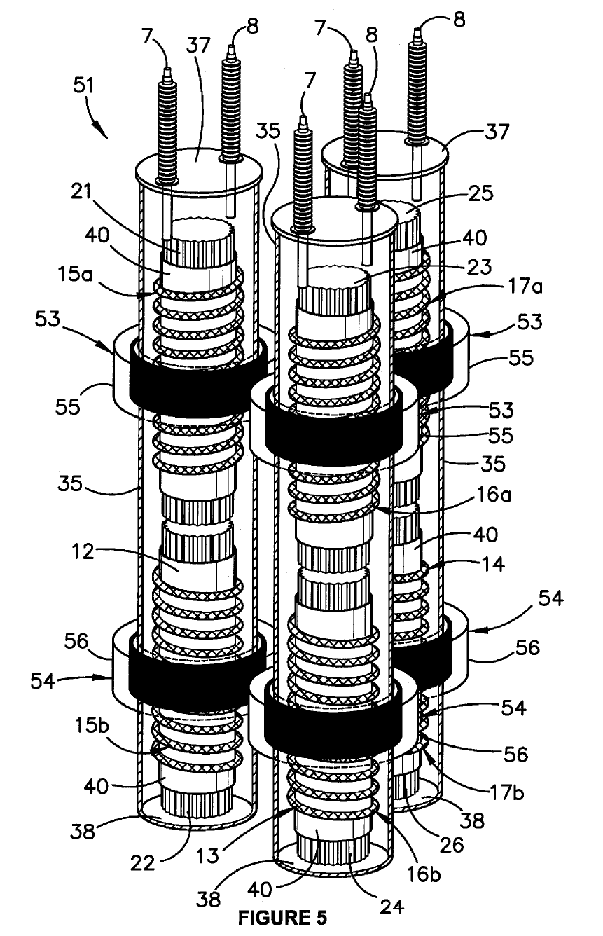

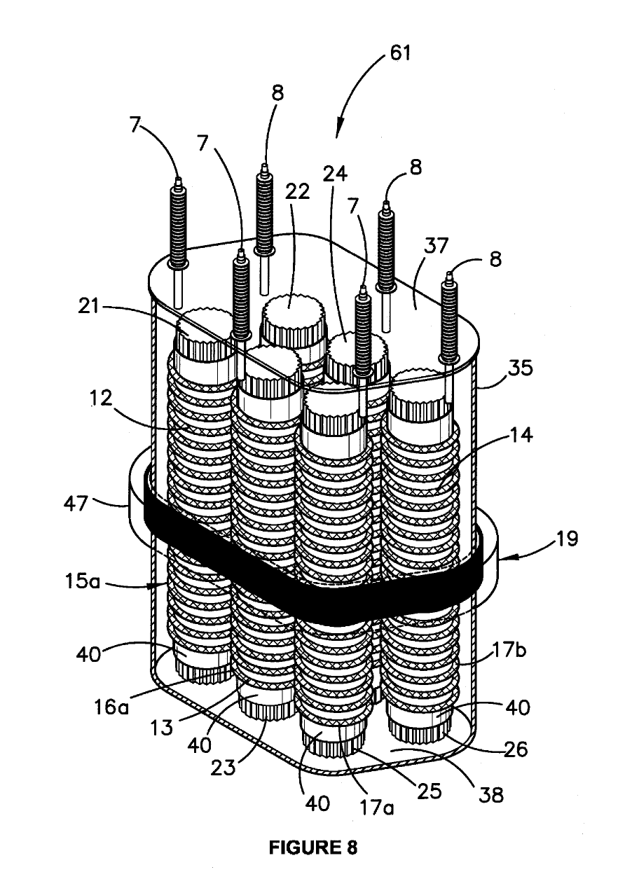

Posts 21 to 26 are substantially parallel and the pairs of posts co-extend within tank 35. In other embodiments, for example as illustrated in FIGS. 5 to 7 and 11 to 16, the pairs of posts are contained within respective like spaced apart tanks 35. In further embodiments, such as those illustrated in FIGS. 8 to 10, the posts are aligned and coextensive and are included within a common tank. In further embodiments, for example as illustrated in FIGS. 17 and 18, the posts are arranged in a linear array and contained within respective like tanks. It will be appreciated by those skilled in the art, with the benefit of the teaching herein, that it other combinations are available for post location and orientation relative to other posts and tanks.

The above embodiments do not require additional dielectric material intermediate the adjacent coils as the insulation provided by the cables is sufficient. Accordingly, the tank or tanks are more for preventing inadvertent or unauthorized access to the coils and core. For example, for preventing inadvertent contact with or damage to the coils or core during transportation and installation of the FCL. In some embodiments, the tank is replaced with a cabinet, external frame, or a support frame.

In some embodiments (not shown) one or both of end caps 37 and 38 are vented or ported for allowing a heat exchange fluid to interact with the cables and posts. In some embodiments the fluid is air that flows between the end caps, while in other embodiments, the fluid is a liquid. Other heat exchange media are also available, as would be appreciated by the skilled addressee.

In the above embodiments the posts all have substantially equal dimensions and cross-sections, and substantially like physical properties. The posts are orientated relative to each other to collectively provide core 11 with at least one longitudinal axis of symmetry. The desire for symmetry is to best ensure that all phases behave similarly. However, in other embodiments, less symmetry is used. For example, in some embodiments the critical design factor is form—particularly where the retrofitting of an FCL into an existing installation is constrained by space—and a degree of asymmetry is tolerated.

Where the more critical design factor is the available footprint, use is made of embodiments where the longitudinal direction is vertical or substantially vertical. For those embodiments where the footprint is less critical, or where the available height is the limiting design factor, the longitudinal direction is horizontal or substantially horizontal. In other embodiments, the longitudinal direction is inclined with respect to both the horizontal and the vertical planes.

In further embodiments, cables 15a is replaced with two separate like cables (not shown) that are co-wound about post 21 in a single layer but along respective longitudinally offset helical paths. The cables essentially co-extend and the ends of the separate cables are electrically connected. This defines two current paths of substantially equal length about post 21 and, hence, for a given current load, the current rating of the separate cables is able to be less than that required from a single cable. In practice, cables with a lower current rating usually also have a smaller diameter and a smaller bending radius. Accordingly, where use is made of separate cables it is possible to have smaller diameter posts and less distance between the posts. All else being equal, this arrangement allows the footprint of the resultant FCL to be further reduced.

It will be appreciated that others of cables 15b, 16a, 16b, 17a and 17b are able to be similarly substituted with respective pairs of separate cables. Preferentially, if use is made of separate cables, that use is made in all AC coils to best ensure symmetry between phases.

In further embodiments, use is made of more than two separate co-wound cables.

The use of these co-wound cables—that is separate cables employed in parallel side-by-side—is possible without the need of complicated transpositioning of conductors. That is, the co-wound cables are maintained at substantially the same length without having to cross each other. In the above embodiments this is achieved by having the separate cables follow respective helical paths that are longitudinally offset.

As illustrated, FCL 6 has an open core configuration. However in other embodiments, FCL 6 has a closed core configuration. It will be appreciated by those skilled in the art that the use of high voltage cables in AC coils is also used for other types of FCLs. For example, such AC coils are applicable to resistive FCLs which act as switches and employ a coil in parallel with those switches.

FCL 6 also includes for each post a hollow generally cylindrical former 40 for receiving the respective post. The individual cables are wound about and secured to the respective formers prior to the post being received. This facilitates the manufacture and assembly of FCL 6. In other embodiments, the order of assembly is otherwise.

As shown, each former extends longitudinally beyond the windings in the respective coil, and each post extends longitudinally beyond the former.

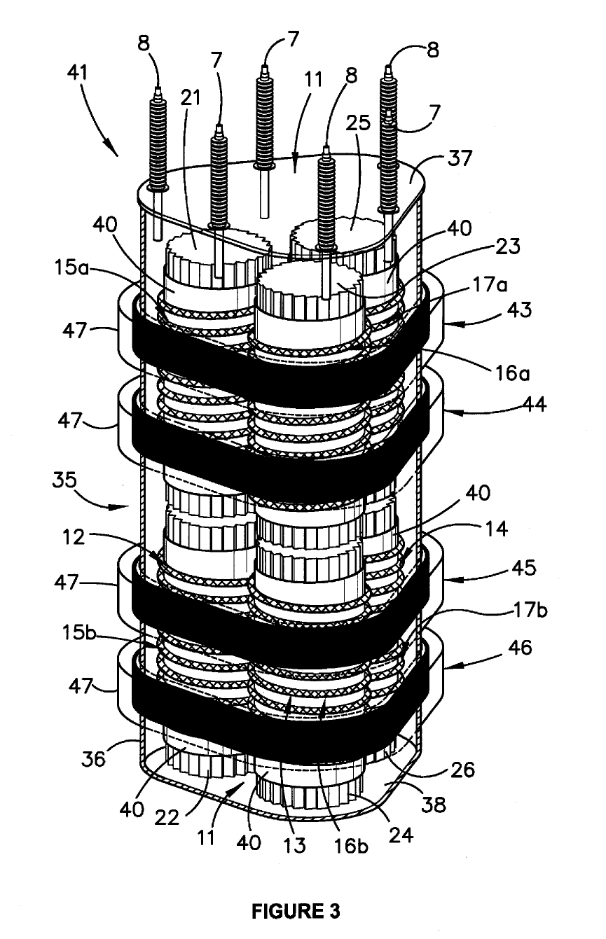

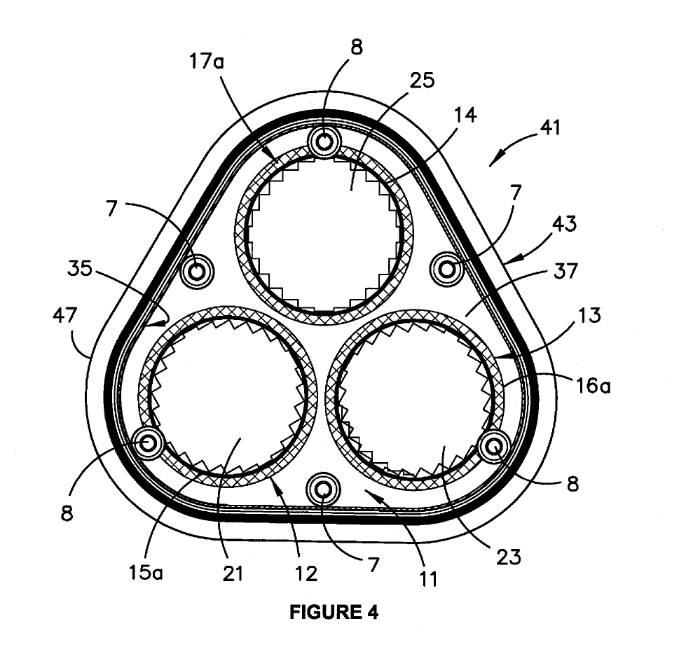

Reference is now made to the FCL 41 illustrated in FIGS. 3 and 4, where corresponding features are denoted by corresponding reference numerals. More particularly, FCL 41 includes four longitudinally spaced apart parallel DC coils 43, 44, 45 and 46. These coils are arranged in pairs, where one pair includes coils 43 and 44, and the other pair includes coils 45 and 46. Each coil is disposed within a respective cryostatic chamber 47. The coils are spaced apart to provide a relatively uniform DC magnetic field in the posts while balancing the energy loss of the cryogenic system.

Reference is now made to FCL 51 in FIG. 5 where use is made of three like, spaced apart longitudinally extending tanks 35. Each tank houses the coils for one phase of the EDS. Moreover, each tank 35 is received within a respective pair of DC coils, where each pair includes two longitudinally spaced apart coils 53 and 54 that are housed within respective cryostatic chambers 55 and 56. The coils 53 and 54 are disposed substantially midway longitudinally relative to the respective post that is received within the coil.

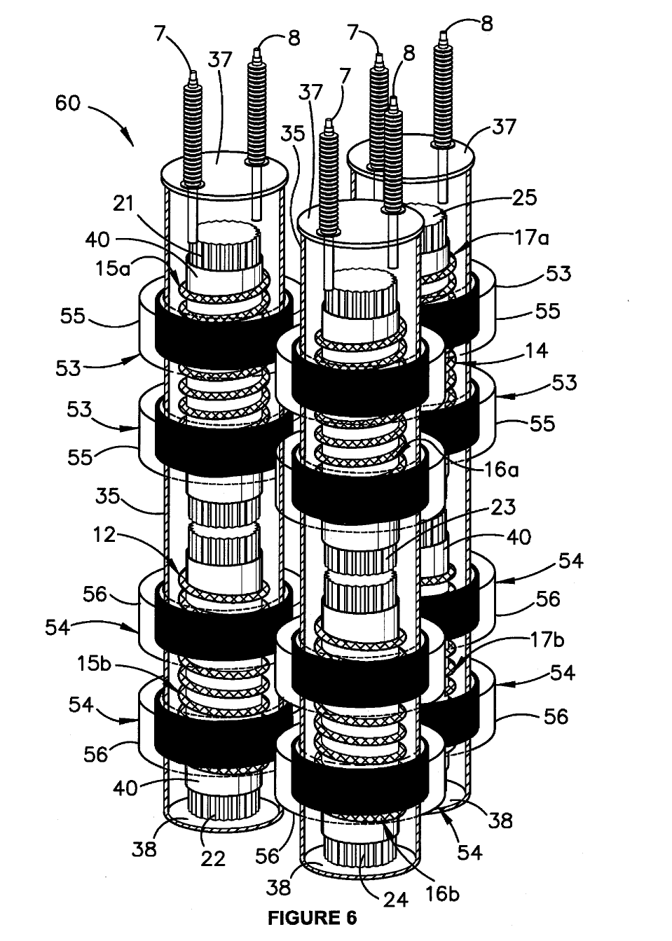

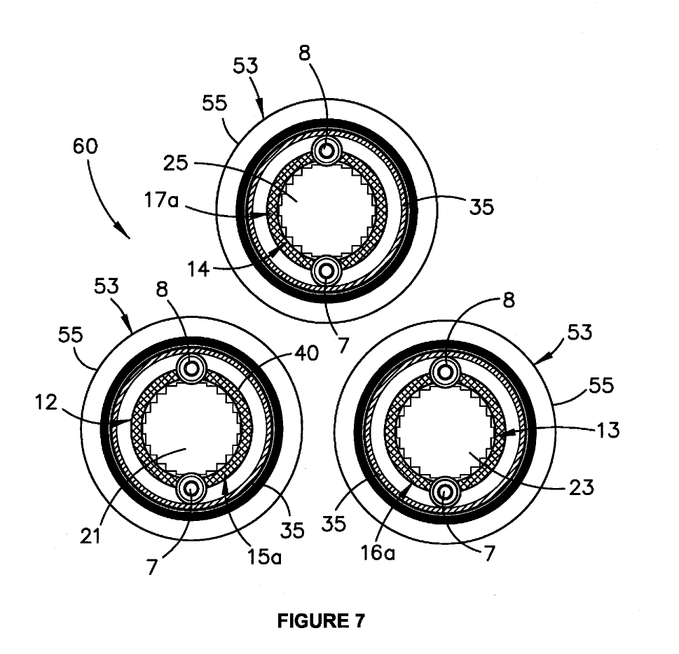

Reference is now made to FIG. 6 and FIG. 7 where there is illustrated an FCL 60 similar to FCL 51, but having double the number of DC coils 53 and 54 to ensure an even biasing of the cores across the area covered by the AC coils. The coils are also spaced apart longitudinally along the respective posts.

Reference is now made to FIG. 8, where there is illustrated an FCL 61 having six posts arranged in a 6×1 array and a single DC coil 19 that is disposed within a cryogenic chamber 47. In this arrangement, all free ends of the cables extend from the respective coils adjacent to end cap 37. Accordingly, there is a substantially equal and relatively short distance required for the cables to extend and connect with respective terminals.

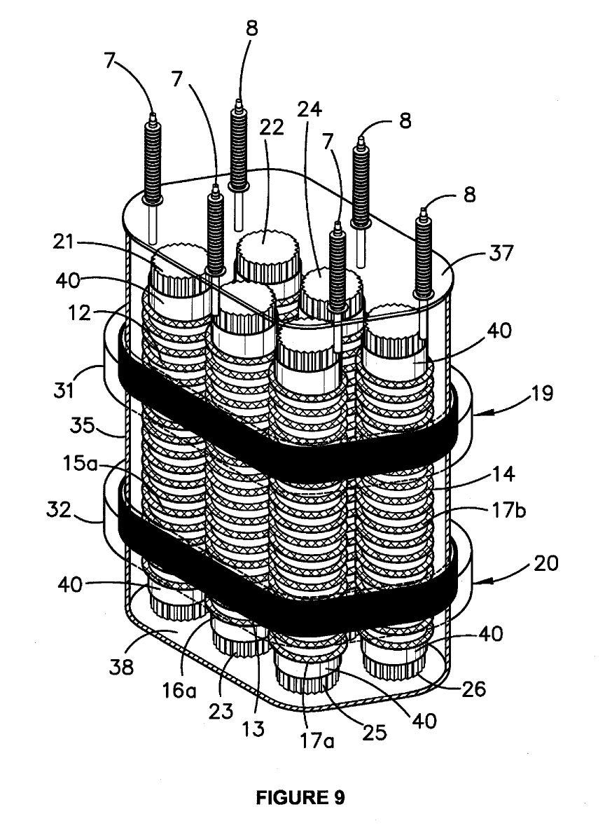

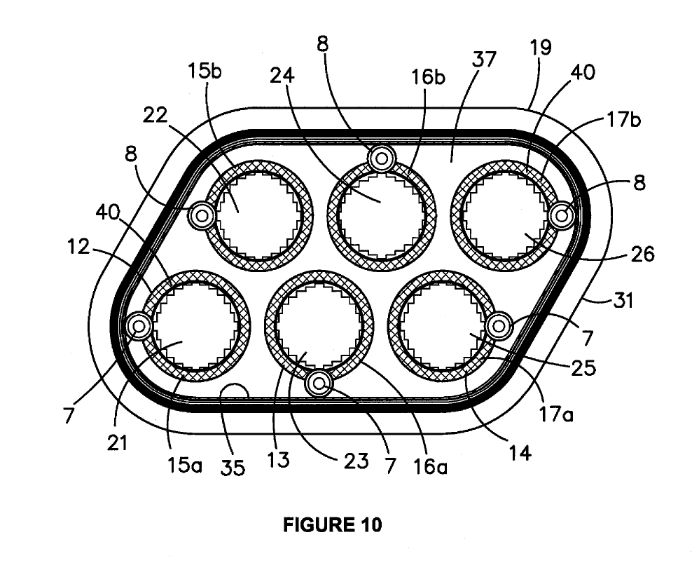

A further embodiment of the invention, similar to that of FIG. 8, is illustrated in FIG. 9 and FIG. 10. More particularly, an FCL 62 includes like features to that of FIG. 8 with the exception of including two DC coils 19 and 20. These coils are longitudinally spaced apart and housed within respective cryostatic chambers 31 and 32.

Reference is now made to FIGS. 11, 12 and 13 where there is illustrated an FCL 65. This FCL includes six posts 21, 22, 23, 24, 25 and 26 defining core 11, and three thin gauge steel tanks 35. Tanks 35 are generally cylindrical and tubular, and extend longitudinally between end caps 37 and 38. The tanks have respective notional axes that are parallel and which extend through a common longitudinal plane. As shown, the longitudinal direction is substantially horizontal.

Posts 21 and 22 are disposed within that tank 35 shown at the forefront of the Figure. Posts 23 and 24 (not shown) are disposed within the middle tank 35, and posts 25 and 26 are disposed within that tank 35 shown rearmost in the Figure. Each tank 35 is received within a respective quartet of spaced apart DC biasing coils. It will be appreciated that some details have been omitted from the foremost and rearmost tanks to provide the addressee with a clearer view of the revealed hidden detail.

Within each tank 35 there are disposed insulating mounts for spacing the posts from the respective tanks 35. In this embodiment, the insulating mounts are in the form of four longitudinally spaced apart crescent shaped insulating cradles 67. These cradles are arranged in pairs to receive respective ends of a given post and to maintain in a longitudinal configuration. The cradles are made from mild steel, although in other embodiments different materials are used.

In other embodiments alternative mounts are used.

It will be appreciated that tank 35 (or all tanks 35) are earthed and the insulating mounts are used to maintain the cable and the posts spaced apart from the sidewall and end caps of the tank.

It will be noted that terminals 7 and 8 extend radially outwardly and upwardly from the relevant sidewall 36, and are adjacent to respective end caps 37 and 38. This obviates the need for cable 15b, 16b, and 17b to extend back along the posts to connect with the respective output terminal.

Tanks 35 are maintained in a fixed orientation by mounting formations 68. In this embodiment the mounting formations are equally spaced apart parallel metal feet that extending radially outwardly and downwardly from each sidewall 36. While in this embodiment the feet are welded to sidewall 36, in other embodiments the feet or other mounting formations are bolted or otherwise secured to sidewall 36. In further embodiments, the mounting formation is separate from tank 35.

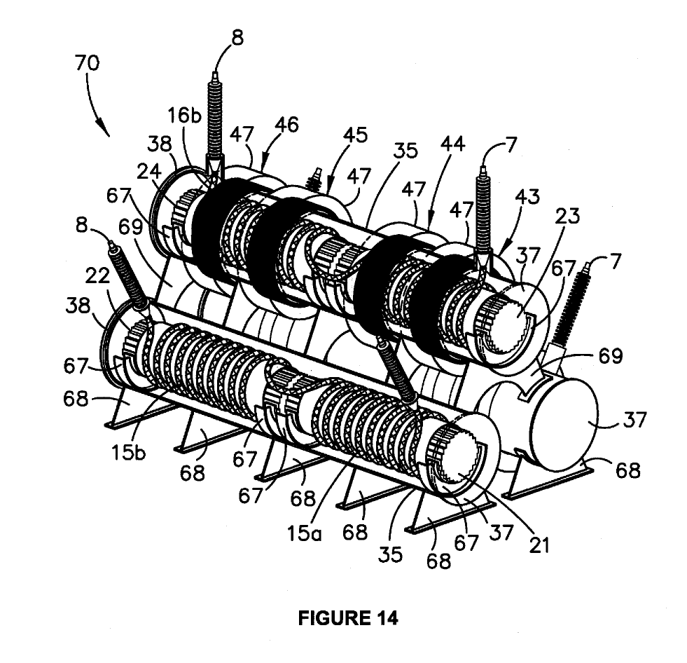

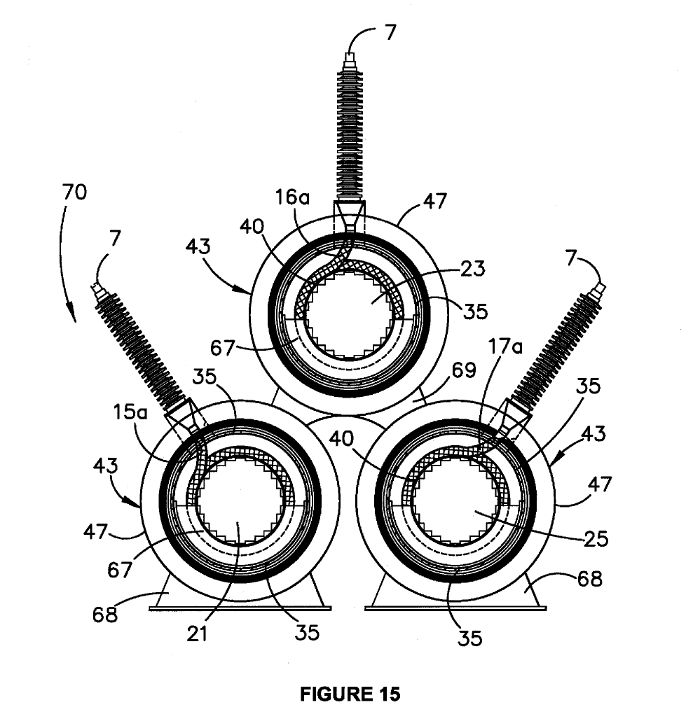

Alternative mounting formations are illustrated in FIG. 14 and FIG. 15. In particular, an FCL 70 includes tanks 35 that are arranged in a triangular stack, where the tanks are parallel and equidistant from each other. For the topmost tank 35, the terminals 7 and 8 extend directly upwardly, while for the other tanks, the terminals are canted outwardly.

The bottom most tanks include a plurality of feet similar to the tanks of FIG. 11. However, the topmost tank includes a different plurality of spaced apart feet 69 for extending between that tank and other two tanks 35.

In other embodiments, tanks 35 are maintained in the desired relative orientation by mounting formations such as a frame or other support structure.

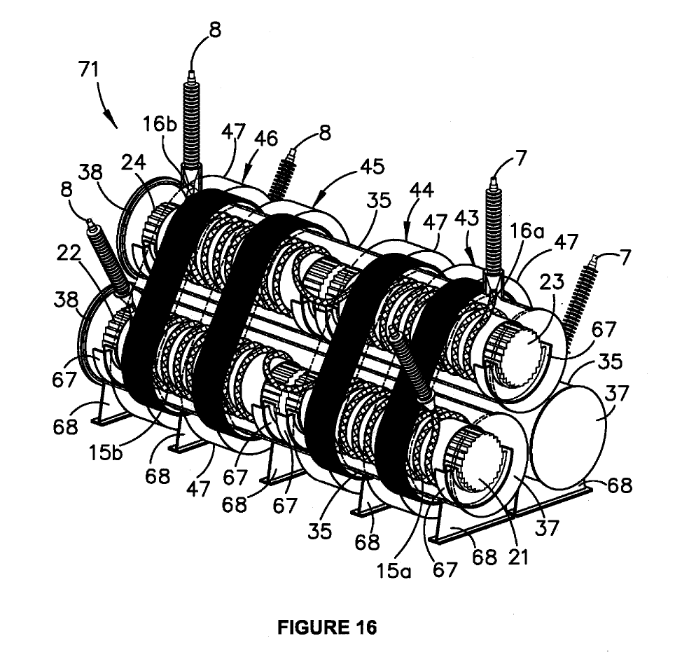

Reference is made to FIG. 16 where there is illustrated an FCL 71 that includes four spaced apart DC coils, where all the tanks 35 are received within each of those coils. That is, the coils are common to all phases of the FCL. In the FIG. 14 embodiment each phase included its own DC coils. It will also be noted that in the FIG. 16 embodiment, terminals 7 and 8 extend though respective end caps 37 and 38, and then outwardly and away from the respective tank.

In the embodiment of FIG. 17 and FIG. 18 use is made of only two longitudinally spaced apart DC coils, where both coils are common to all phases.

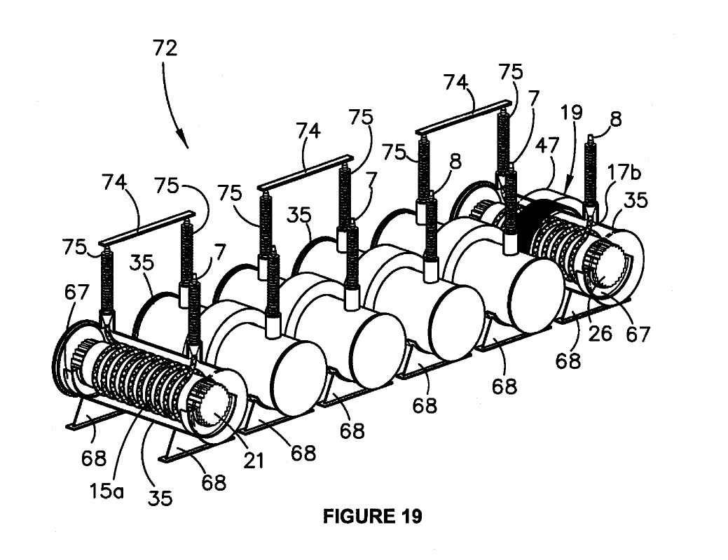

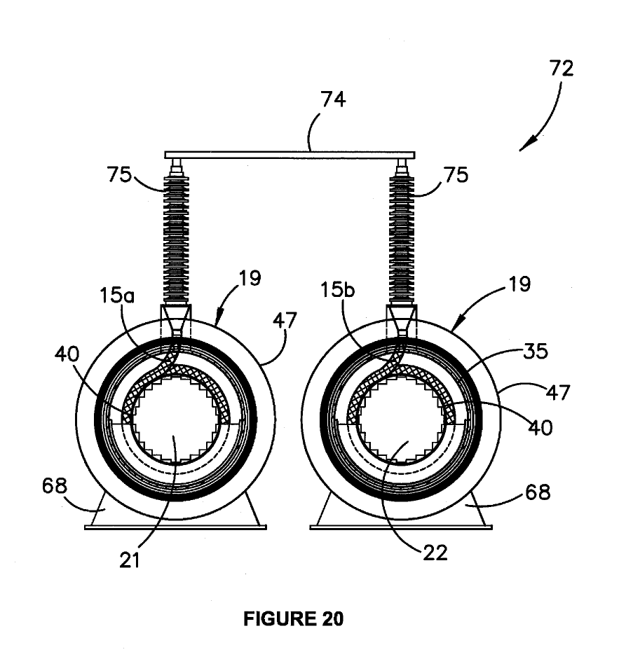

A further embodiment is illustrated in FIGS. 19 to 21 where an FCL 72 includes six tanks 35 for containing respective posts and which are arranged side-by-side in a linear 6×1 array. The posts associated with the same phase are adjacent to each other, and connected by a respective bus bar 74 that extends between intermediate terminals 75. This configuration allows for the terminals 7 and 8 to emerge from adjacent end caps of the tanks, and obviates the need for the cable to extend back along the windings within the tank. It will be appreciated that each tank 35 is received within a respective DC coil and its associated cryostatic chamber.

In another embodiment (not shown) similar to that of FIG. 19, the coils for each phase are formed from a single continuous cable that extends between the adjacent tanks. That is, use is made of three cables, one for each phase.

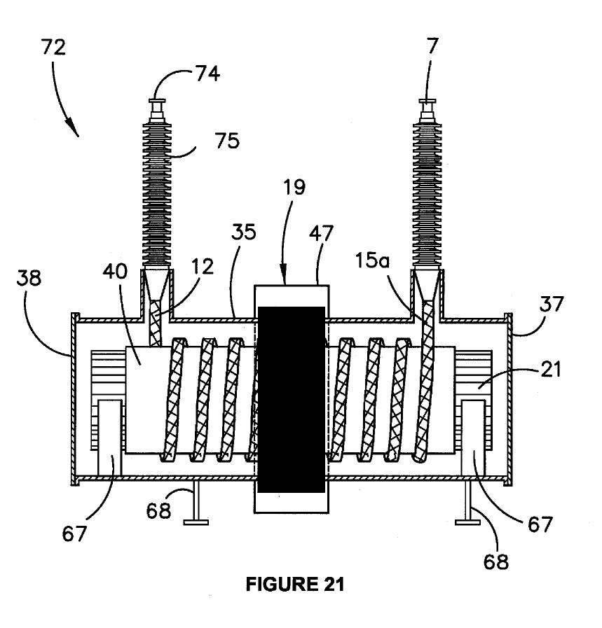

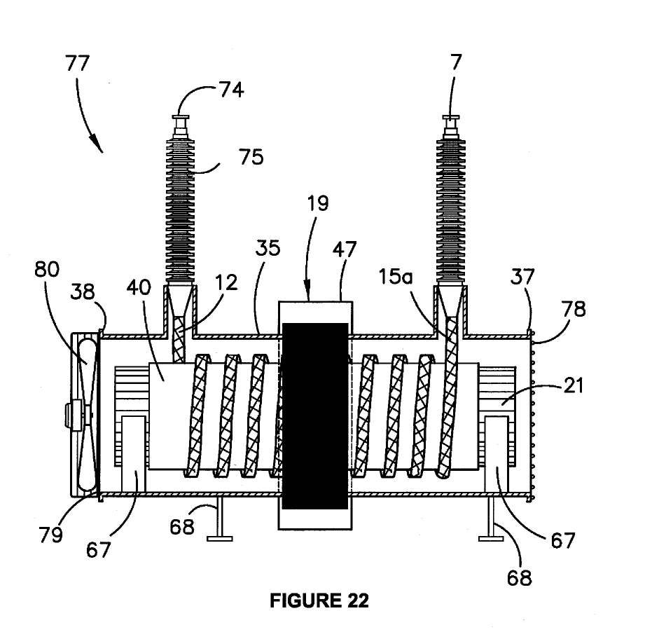

FIG. 22 illustrates a further embodiment, in the form of an FCL 77. This FCL is similar to that of FIG. 21. However, the tank of FCL 77 includes vented end caps 37 and 38. More particularly, end cap 37 is a grille 78, and end cap 38 includes a grille 79 and an electrically driven fan 80. This allows an airflow to be established through tank 35 to facilitate cooling of the FCL.

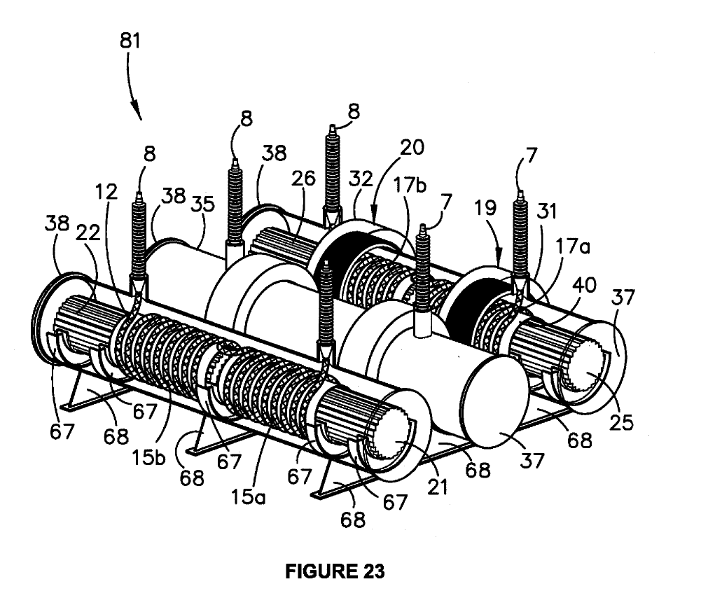

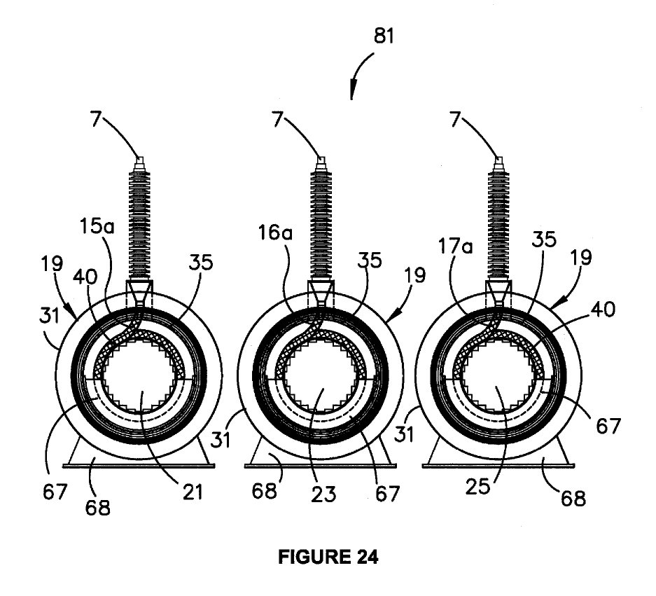

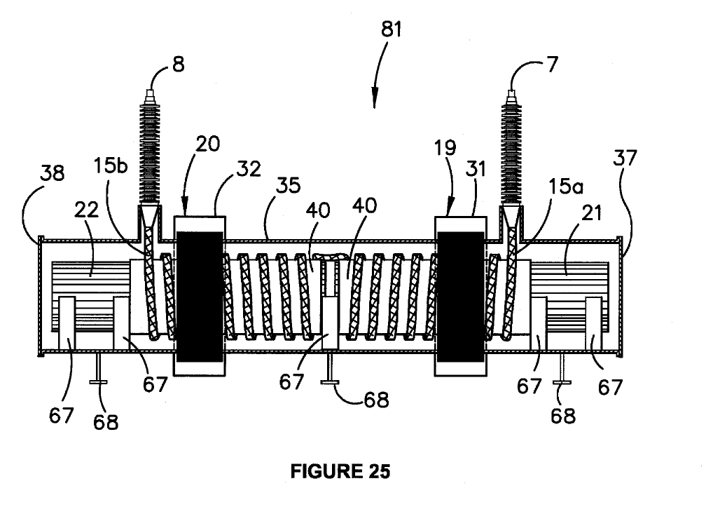

FIGS. 23 to 25 illustrate a three phase FCL 81 having a 3×2 array of posts similar to the FCL of FIG. 11. However the posts included within FCL 81 have a greater longitudinal length than those used in the FCL of FIG. 11. More particularly, the posts in FCL 81 have a longitudinal post length and the coils about those respective posts have longitudinal coil length. It has been found by the inventor that by increasing the ratio of the longitudinal post length to the longitudinal coil length it is possible to rely upon a smaller number of HTS windings in the DC coil or coils to achieve the required magnetic bias within the posts. This allows FCL 81 to provide, relative to the FCL of FIG. 11, savings in construction materials and savings in operating costs. However, FCL 81 does require additional volume at the installation. That is, where the longitudinal extent of the posts is limited due to design constraints, the embodiment of the invention deployed will include a greater portion of the post about which the AC coil is wound. Where there is less constraint, the portion will be lesser to gain the advantages mentioned above.

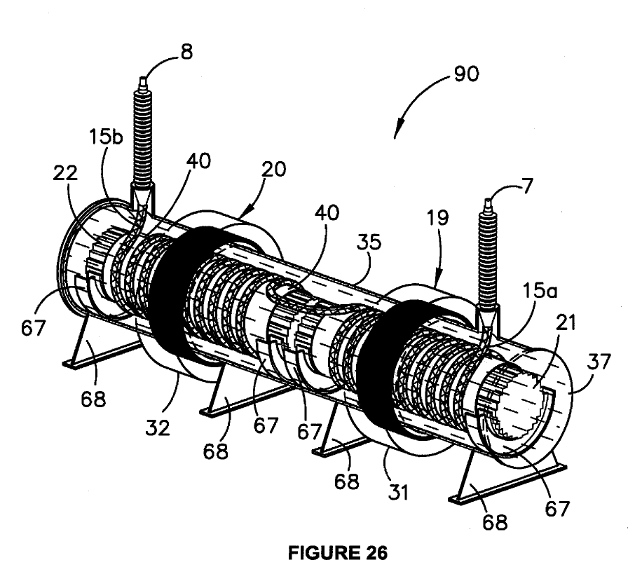

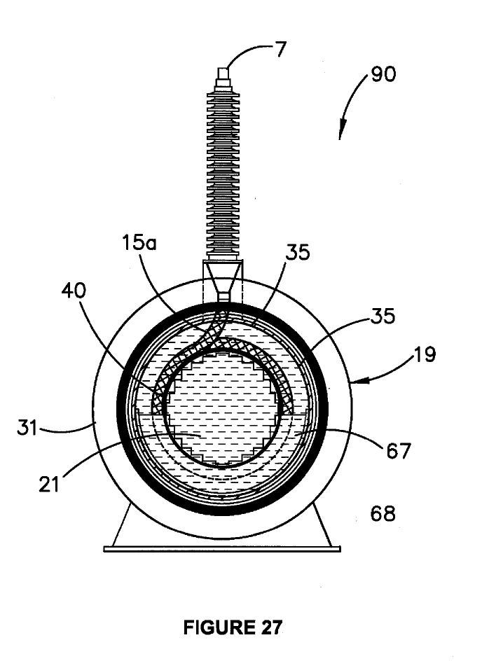

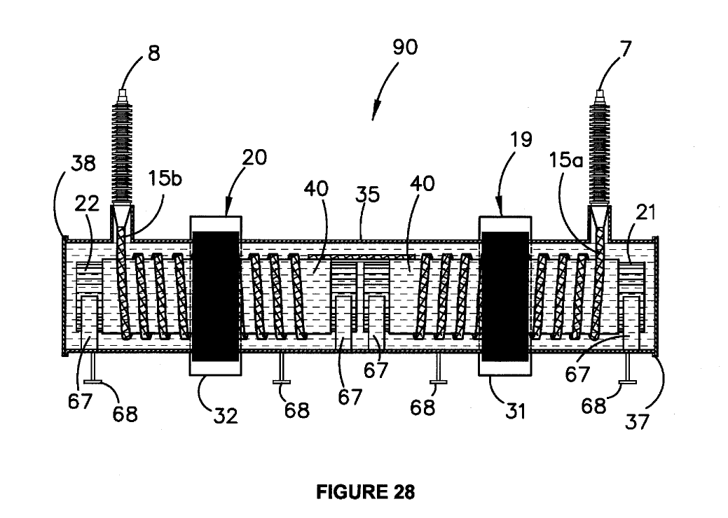

In FIGS. 26 to 28 there is illustrated a single phase FCL 90. This FCL includes a cooling fluid within tank 35. More particularly, use is made of a transformer oil that is circulated though a remote reservoir and heat exchanger to assist with the temperature management of the posts and cables. Although the use of a cooling fluid of this type has only been specifically illustrated with reference to a single phase FCL, it will be appreciated that it is equally applicable to a multiphase FCL. Moreover, in this embodiment, the cable is CTC cable—that is, continuously transposed cable.

In other embodiments, use is made of paper or Nomex™ fabric covered copper cables which are not insulated to as higher voltage as the other cables mentioned in this specification.

The use of high voltage insulated cables 15a, 15b, 16a, 16b, 17a and 17b allows the elimination of one or more of: dielectric fluids which are environmental contaminants; greenhouse gasses such as SF6; and fire hazardous materials such as oil. This also simplifies the construction of tank 35, as it need neither be sealed nor designed to contain any hazardous material under fault conditions. This also greatly reduces the cost of such a tank or enclosure. Where the safety or other aspects of the design require the use of one or more of dielectric fluids etc, this is able to be accommodated by the embodiments.

The embodiments illustrated in FIGS. 11 to 28 all include longitudinally extending posts, and terminals that are longitudinally spaced apart. In some embodiments the terminals extend from the sidewall of tank 35, while in other embodiments, the terminals extend from caps 37 or 38. It will also be noted that in some embodiments the terminals for a given post or pair of posts are parallel, while in other embodiments, those posts are canted or inclined away from each other. This longitudinal spacing of the terminals allows for shorter lengths of the cable to be used in each AC coil. Moreover:
The cable need not be looped about to be routed back to the same end of tank 5, and the ends of the cable are able to feed directly to the terminals. This allows the bending radius of the cable is a less significant design parameter. That is, it allows the use of cables that have relatively high bending diameters or, alternatively, the use of a tank 35 of smaller volumes for cables within a smaller bending diameter.
Tank 35 is able to be of smaller diameter as space for the return cable need not be provided.

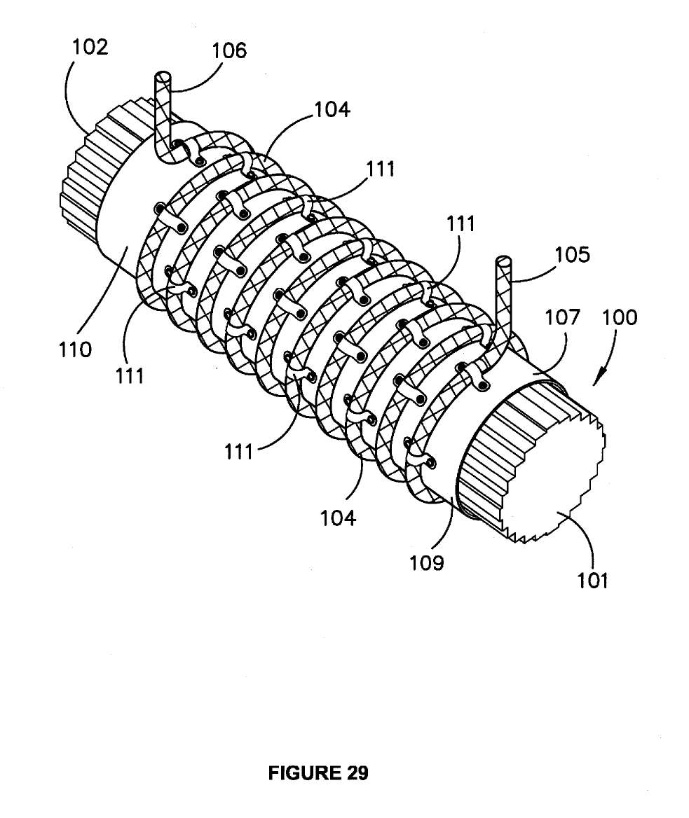

Reference is now made to FIG. 29 where there is illustrated a core for a fault current limiter, where the core is in the form of a laminated steel post 100 that extends longitudinally between ends 101 and 102. The laminations that collectively define post 100 are constructed from a high permeable material, which in this embodiment is a high permeable steel. An AC coil, defined by a high voltage cable 104 that extends between ends 105 and 106, is wound about a generally cylindrical steel AC coil former 107. The former extends longitudinally between ends 109 and 110, and receives post 100 such that ends 109 and 110 are respectively adjacent to ends 105 and 106.

Cable 104 is wound about former 107 along a generally helical path and is maintained in this configuration by an AC coil retention system in the form of a plurality of metal clamps 111 that are spaced apart along the helical path. In this embodiment, the spacing between adjacent clamps along the path is substantially uniform. It will be appreciated that former 107 includes a corresponding plurality of pairs of apertures for allowing clamps 111 to be positively secured to the former. In this embodiment, the securing of the clamps to the former is by way of bolts. In other embodiments, different securing devices and/or formations are used. For example, in a further embodiment, the clamps are integrally formed from the former 107 rather than being separate elements. In other embodiments, the clamps are formed from tabs that are punched in the former and which provide spring loaded clamps into which the cable is inserted and captively retained.

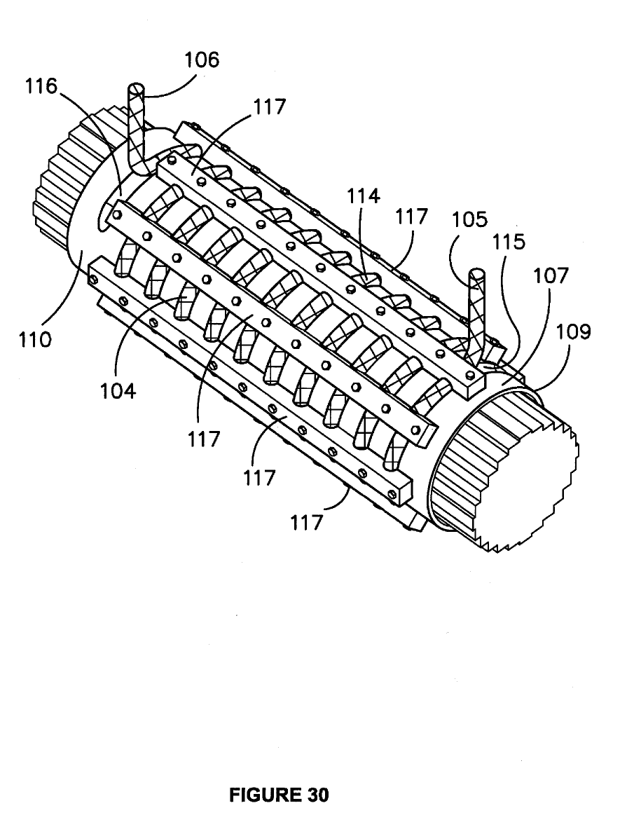

A further embodiment is illustrated in FIG. 30 where there is provided an alternative AC coil retention system. Particularly, former 107 includes two circumferentially extending longitudinally spaced apart formations 115 and 116 for receiving and more positively locating respective ends 105 and 106 of cable 104. Moreover, use is made of a plurality of longitudinally extending, equally circumferentially spaced apart retaining strips 117. Each strip is secured positively to former 107 by a respective plurality of bolts. These bolts lie between each turn of cable 104, and also longitudinally beyond the first and final turns.

Each strip 117 includes an array of locating formations for receiving and engaging cable 104, and for positively locating the cable along the helical path.

Recesses 115 and 116 also assist in restraining cable 104 under fault current forces, as well as more positively locating cable 104 on former 100 during winding. These recesses have a maximum depth, in this embodiment, of about 50% of the cable diameter. However, in other embodiments different maximum depths are used. It has been found by the inventor that maximum depths in the range of about 10% to 50% of the cable diameter are preferred.

Strips 117 are manufactured from compressed transformer board. However, in other embodiments, different electrical insulation materials are used. Example of other such materials include GFRP, other composite products, and combination of all of the foregoing. In addition, in other embodiments, electrically conductive materials are employed. In still further embodiments, strips 117 are constructed from a combination of conductive and non-conductive materials.

Preferably, strips 117 are also good thermal conductors to facilitate transportation of cable heat loss to the restraints and then to ambient. In some embodiments use is made of natural convection to assist with heat management issues, while in other embodiments use is made of forced convection. In further embodiments, strips 117 have cooling fins or other heat exchange formations fitted.

Suitable high voltage cables are made with solid insulation and rated to the supply line voltage and able to pass all necessary IEEE transient electrostatic over-voltage tests. The cables are also rated to carry their full current and to have a temperature rise at this full current level which can be handled by the insulation. Typical solid cable insulation materials are impregnated paper, synthetic polymers such as PE, XLPE and EPR for medium voltage cables and XLPE and EPR for high voltage cables. Various insulation materials exist for medium voltage underground distribution cables such as high density polyethylene (HDPE), tree resistant XLPE and EPDM.

It has been found that, while it is able to be used, special armored high voltage cable is not required and neither is a neutral return conductor.

Other suitable cable includes high voltage solid insulated super flexible mining cables which are composed of many thousands of fine strands of conductor. Such high voltage cables have flexible rubber insulation such as EPR and are covered in a flexible over-sheath such as a thermoplastic. Typically, these are employed for mobile sub-stations, emergency power, and in the mining industry where portability and flexibility are crucial and also where multiple reeling and de-reeling operations are common. These cables are also referred to as “portable HV cables” or “mining cables” by some manufacturers or simply HV cables. In use in the embodiments of the invention, these cables are subjected to much less repetitive mechanical strain than they are designed for. Accordingly, in some embodiments, the cables are modified to reduce their diameter and, preferentially, decrease their allowed minimum bending radius. For example, some cables have the armoring simplified, while other have the outer sheath removed either partially or completely. These modifications are applicable for use with the present embodiments for, in general, the cable components referred to above do not infer additional dielectric strength but are employed for protection, mechanical strength, and armoring against environmental conditions. For the embodiments of the invention disclosed in the drawings, the primary function of the cable is to provide dielectric, not mechanical, properties. Accordingly, when applied to at least some embodiments, it is possible to simplify the cable design to gain additional advantage in an FCL.

Some typical examples of cables which are available commercially have the following basic specifications:

| Voltage | Current | Outside | . Bending | Min. bending |
|---|---|---|---|---|
| Rating | Rating | Diameter | Radius | Diameter |
| (kV) | (A) | (mm) | (mm) | (mm) |
| 33 | 1050 | 55 | 330 | 660 |
| 69 | 1050 | 80 | 480 | 960 |
| 69 | 280 | 57 | 342 | 684 |

The bending diameter formula that generally applies to flexible mining cable is as follows:

Minimum bending radii of HV mining cable=6×Outside diameter of cable

However, it should be noted that considerable scope exists for simplifying the HV cable structure design to allow for more current and smaller bending radii. For example, in some embodiments thinner overall PVC protective sheath is employed, as the cable will not be install in wet, abrasive, or mechanically challenging locations. In addition, in some embodiments, lower bending radii are allowed for in the cable design by specifying this to manufacturers and testing and qualifying the cable under tight bending radii. For example, where mining cable is employed in a coil with a once off bend during coiled winding, and no further repetitive bending, a bending radii as low as four times the outer diameter is achievable.

The HV cables are most applicable to the open core FCL embodiments referred to herein. Due to the nature of the cables, use is also preferentially made in the embodiments of permeable cores including posts having a substantially circular transverse cross section. However, it will be appreciated by those skilled in the art that the HV cables are not limited to the open core FCLs or to posts having a substantially circular transverse cross section.

While there has been a limited use of high voltage cables in transformers and industrial reactors, it has been found to be unpopular and impractical for many reasons. Two main problems are the resultant size of the coils and the large eddy current losses encountered. These factors suggest that high voltage cables should also be problematic when applied in the field of fault current limiters. However, it has been discovered by the inventor that these problems are able to be practically addressed and for additional advantages to arise from an FCL using such high voltage cable. To assist the addressee, the following commentary is provided.

Those skilled in the art of high voltage transformers will appreciate that such transformers usually employ many hundreds of turns of conductors. And where high voltage cable is employed for AC applications, the cross-section of the conducting region effectively forms a single bulky conductor. Large cross-section copper conductors in AC applications are vulnerable to high “copper eddy current losses”, which is distinguishable from “steel lamination eddy current losses”. High copper eddy current losses are avoided in transformers by breaking up the conductor into a number of individually insulated strands. This technique reduces the copper eddy current losses substantially. When this technique is employed in transformer windings, one speaks of winding a number of conductors “in hand”. Large transformers are wound with between 4 and 64 conductors in hand. The higher the current rating, the greater the number of conductors required. In a transformer, winding the AC coils with a HV cable effectively removes this technique from the design and copper eddy current losses will be greater. To solve this would require the use of a number of smaller conductors that were transpositioned along the length of the winding to provide cables of equal length. This crossing of the paths of the cables would provide even greater radial build-up. Either way, the radial build-up is very large and usually unacceptably large to be practical.

The FCLs of the present invention allow the use of high voltage cables while containing the radial build-up by:
Having very few layers of windings—and often only one layer—within a given coil.
Not requiring co-wound cables to cross paths.
Only using relatively few windings in each AC coil.

Where use is made of two (or more) co-wound cables, the two smaller diameter cables (that is, smaller in cross-section) are used in parallel side by side to form the required AC coil. Such smaller diameter cables are wound on a tighter former, as opposed to larger diameter cables which cannot be wound on tight formers. In some embodiments of the invention, the FCLs are smaller than transformers. Thus, smaller diameter cables are advantageous. As mentioned, the typical bend radius is six times the cable cross-sectional diameter. Hence, if an embodiment of the invention requires a 1,000 A cable rating, two sets of 500 A cables are placed side-by-side.

It has been found that for the embodiments of a DC saturated core FCL wound with high voltage insulated cable, the copper eddy current losses are relatively low—and in most of the above embodiments negligible—compared to that encountered in transformers. This arises from the above embodiments having the cable exposed to a relatively low AC magnetic field compared to that of a transformer. During normal operation of the FCL, the magnetic field is dominated by the DC component. Additionally, in the FCL embodiments above, the cable or cables are wound through only a small number of turns relative to that required in a transformer.

A further factor that contributes to the favourable function of HV cables to the embodiments is that the AC coils is exposed to a combination of DC and AC magnetic fields which do not oscillate symmetrically around the zero of the B-H curve but, rather, around a minor loop. This also reduces the copper eddy current loss phenomenon.

The above factors also apply to the steel core eddy current losses which, for the embodiments disclosed, are negligible as the core of the FCL is also biased during normal operation and also does not oscillate symmetrically about the zero of the B-H curve.

The FCLs of the embodiments are able to use a greater range of HV cables than would be suitable to a transformer application. For, relatively to transformers, the FCLs of the invention have: negligible or greatly reduced eddy current losses in the HV cable; negligible or greatly reduced eddy current losses in the steel core; and greatly reduced I²R losses in the cables, for those cables need not be as long as is required in transformer applications. This allows the cables used in the embodiments to be rated for lower temperatures due to there being less heat build-up. In addition, and as mentioned above, the cables used in the embodiments need not be designed for high levels of repeated mechanical stress. Both these factors alone are advantageous, but collectively provide the FCL designer with considerable flexibility.

The use of HV cables in the FCL embodiments, as opposed to winding copper strip directly, reduces manufacturing costs and times. The process of winding copper strip is time consuming and labour intensive as multiple strands “in hand” need to be wound. High voltage insulated copper cable on the other hand is mass-produced and is wound directly on a former without any additional manual insulation techniques.

### Example Calculation 1

In one particular embodiment, for example, the following design values show the cost advantage of employing high voltage insulated AC cables.

| | | Traditional Conductor |
|---|---|---|
| Value | HV Cable | Winding Techniques |
| Current rating (A) | 1,000 | 1,000 |
| Number of AC turns required | 25 | 25 |
| Number of conductors in hand | 1 | 4 |
| Cross sectional area of high | 0.4 | 0.4 |
| permeability core (m²) | | |
| Diameter of core (mm) | 752 | 752 |
| Length of AC cable or conductor | 60 | 240 |
| needed per coil (m) | | |
| Unit Cost of AC coils per phase | 1 | 2 |
| Unit cost of AC coil construction | 1 | 4 |
| Diameter of HTS coil (mm) | 922 | 1,150 |
| DC bias required (AT) | 1,200,000 | 1,200,000 |
| Current rating of HTS tape at 30 K | 155 | 160 |
| in coil form | | |
| Number of DC turns required per | 7,742 | 7,500 |
| phase | | |
| Length of HTS tape needed (km) | 22.4 | 27.1 |
| Unit cost of HTS tape per phase | 1 | 1.2 |

In the above example, the combination of cost savings is considerable and often amounts to many hundreds of thousands of dollars for a given FCL. And while the above example concentrates on the cost savings from the AC coil manufacture, labour savings, and the reduced amount of HTS tape required (through smaller diameter HTS coils), there are other cost savings also made but not included. For example, as the HV cables need not be immersed in a dielectric material, the cost of the tank is reduced. For example, if a lower specification tank being used, or the tank omitted altogether.

The use of HV cables for the AC coils additionally contributes to lower manufacturing costs as the techniques for terminating HV cables are generally well understood and easily achieved in practice.

There are also ongoing cost-savings able to be realized through reduced energy use as a result of lower cryogenic losses from the smaller surface area DC coils.

The use of HV cables in the embodiments of the invention also allow the DC HTS coils to be of reduced diameter. More particularly, the cables enable smaller clearances between adjacent AC coils and between the AC coils and the tank. As mentioned, above, some embodiments do not include a tank or other dielectric medium containment vessel. The surface areas of the cryostats in these embodiments are reduced, which reduces the cost of the associated compressors and materials used in the cryogenic system. Moreover, it has been found that the ongoing cost of running the cryogenic system is also reduced. For example, the losses at a 30° K operating temperature for the HKS DC coil are highly magnified in terms of wall surface area by a factor of 300 or so. That is, a single Watt saved at 30° K is worth about 300 W in terms of saved room temperature input power. So even a reduction in the surface area of the cryogenic housing for the DC coil of 20% provides a significant ongoing advantage. These operating factors are not a consideration for transformers and industrial reactors as these do not make use of HTS coils.

### Example Calculation 2

To provide an indication of the level of energy savings for similarly rated FCLs, the following table compares various characteristics of an embodiment of the invention with an FCL using traditional conductor winding techniques for the AC coils.

| | | Conductor |
|---|---|---|
| | | Winding |
| Characteristic | HV Cable | Techniques |
| Height of cryostats (mm) | 400 | 400 |
| Inner diameter of cryostats (mm) | 900 | 1,130 |
| Outer diameter of cryostats (mm) | 980 | 1,210 |
| Surface area of cryostats (m²) | 2.36 | 2.94 |
| Estimated loss at 30° K from cryostats (W) | 120 | 150 |
| Cold heads needed per cryostat | 4 | 5 |
| (Each providing 30 W cooling power at 30° K) | | |
| Wall power to cool thermal losses from surface | 38.4 | 48 |
| area (kW) | | |

The reduction in wall power required to compensate for cryostat thermal losses leads to savings in energy that would otherwise be provided to the downstream load circuit. In addition to the cost savings generated, there also provides for a reduction in carbon dioxide emissions, as indicated in the following table. The figures provided are for the FCL of the invention and the prior art FCL specified in the immediately preceding table.

| | Savings Associated |
|---|---|
| | with Example |
| Item | Embodiment |
| Rate of Carbon dioxide emission (kg CO₂/MWh) | 900 |
| Savings accrued using High voltage cable | 84.15 |
| (MWh/year) | |
| Energy savings over 10 years (MWh) | 841.5 |
| Carbon dioxide saving over 10 years associated | 757.4 |
| with ancillaries energy saving (Metric tonnes) | |

These savings are only based on manufacturing. There is also a saving realized in the cost of transportation and installation.

Electrical devices such as transformers and FCL that include oil-filled tanks need an enclosure to capture that oil should there be a leak or a catastrophic explosion. This external oil capture is usually a wall of appropriate height which increases the footprint required for an FCL installation. FCLs are generally installed in a bus tie or directly in a feeder location. While the substation layout and oil capture devices may be suitable for the installation of transformers, it is not necessarily suitable for the installation of FCLs. It has been found that in many cases the reduced footprint of the FCL achievable through use of HV AC cables in the FCL allows this issue to be addressed.

Some advantages of embodiments of the invention include:
Elimination of oil and hence reduction of fire hazard.
Simplification of AC coil winding design and bushing termination design.
Simplification of FCL design by omitting a cable extending from the bottom to the top of the oil tank.
Smaller footprints. By using flexible, insulated, HV AC mining cables, the large electrostatic insulation clearances between phases, phase to oil tank, and between the bushing feed-through and the top of the core are eliminated.
Smaller footprint design allows less HTS tape to be employed to manufacture the DC coil.
Reduced energy and carbon dioxide production.
Flexibility of design, allowing for application to a greater number of installations.

While the above embodiments have been described with reference to specific supply voltages, it will be appreciated by those skilled in the art, that further embodiments of the invention find application with different supply voltages.

The posts include respective magnetic axes that extend longitudinally through the post. Preferentially, all magnetic axes of the posts in a given array of posts are parallel. Where a post coextends with another post, the respective magnetic axes of those co-extensive posts are preferentially parallel, and radially offset. Where the posts are stacked—for example, in FIG. 2—the magnetic axes of the posts in a given stack are preferentially coaxial. It will also be appreciated that, in some embodiments—again, such as that embodiment illustrated in FIG. 2—that some posts are stacked relative to at least one other post in the array, while being coextensive with at least one further post in the array.

In the FIG. 2 embodiment, the stacked posts are spaced apart from the adjacent post in the stack. In other embodiments, the stacked posts abut.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the terms “connected” or “coupled”, when used in the claims, should not be interpreted as being limitative to direct connections only. The terms “coupled” and “connected,” along with their derivatives, may be used. It should be understood that these terms are not intended as synonyms for each other. Thus, the scope of the expression a device A electrically connect to a device B should not be limited to devices or systems wherein an output of device A is directly connected to an input of device B. It means that there exists an electrical path between an output of A and an input of B which may be a path including other devices or means. “Coupled” or “connected” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A fault current limiter for electrically connecting an AC source to a load, comprising:
at least one AC coil for carrying a load current provided by the source to the load, wherein the coil includes a high voltage cable.

2. A fault current limiter according to claim 1 wherein the coil includes a plurality of windings, and the cable defines at least one of the windings.

3. A fault current limiter according to claim 2 wherein the cable defines all the windings.

4. A fault current limiter according to claim 1 wherein the cable is segmented.

5. A fault current limiter according to claim 1 wherein the cable is continuous.

6. A fault current limiter according to claim 1, wherein the at least one AC coil includes a plurality of AC coils, the plurality of AC coils including respective high voltage cables.

7. A fault current limiter according to claim 1, further comprising:
a magnetically saturable core about which the cable or cables are wound.

8. A fault current limiter according to claim 7, further comprising:
a plurality of cables, wherein the core includes a plurality of posts about which respective cables are wound.

9. A fault current limiter according to claim 8 wherein the posts are substantially parallel.

10. A fault current limiter according to claim 8 wherein the posts are substantially coextensive.

11. A fault current limiter according to claim 8 wherein the posts are spaced apart.

12. A fault current limiter according to claim 11 wherein at least two posts are spaced apart from each other such that the respective cables are abutted or closely adjacent to each other.

13. A fault current limiter according to claim 1 wherein the AC coil includes at least two AC cables.

14. A fault current limiter according to claims 13 wherein the two AC cables are wound in parallel.

15. A fault current limiter according to claim 13 wherein the two AC cables each include an input end and an output end, wherein the input ends are electrically connected to each other and the output ends are electrically connected to each other.

16. A fault current limiter according to claim 15 wherein the two AC cables are mechanically connected to each other at a plurality of locations intermediate the input and output ends.

17. A fault current limiter according to claim 13 wherein the two AC cables are substantially coextensive.

18. A fault current limiter according to claim 1, further comprising:
a housing extending between two longitudinally spaced apart ends;
an input terminal being coupled to the housing at or adjacent to one of the ends for electrically connecting to the AC source;
an output terminal being coupled to the housing at or adjacent to the other of the ends for electrically connecting with the load; and
a current limiting element that is received within the housing for carrying the load current between the input terminal and the output terminal, wherein the element: includes the cable wound about a coil axis that extends longitudinally; and is responsive to one or more characteristics of the load current for moving from a low impedance state to a high impedance state.

19. A fault current limiter according to claim 1, comprising:
an input terminal electrically connecting to the AC source;
an output terminal electrically connecting to the load;
a magnetically saturable core;
a high voltage cable electrically connecting the input and the output terminals and for allowing the load current to flow from the source to the load, wherein the cable is wound about a portion of the core; and
a DC coil inducing a magnetic field in at least the portion of the core wherein the field magnetically biases the core such that the AC coil moves from a low impedance state to a high impedance state in response to one or more characteristics of the load current.

20. A fault current limiter according to claim 1 wherein the load current includes multiple phases and the current limiter includes a plurality of input terminals, output terminals and AC coils for each phase, wherein each coil includes a respective high voltage cable wound about the core.

21. An electrical distribution system, comprising:
a transformer for providing a predetermined maximum current at a predetermined operating voltage, the transformer including: first input terminals for connecting with an electrical power source that provides a first operating voltage; and first output terminals that provide a load current at the predetermined operating voltage; and
a fault current limiter having:
a) second input terminals electrically connecting to the first output terminals;
b) second output terminals electrically connecting with a load circuit that draws the load current;
c) a magnetically saturable core;
d) a plurality of AC coils electrically connecting second input terminals and second output terminals and through which the load current flows to the load, wherein the coils each include a respective high voltage cable wound about the core; and
e) at least one DC coil inducing a magnetic field in at least that portion of the core about which the cables are wound, wherein the field magnetically biases the core such that the AC coils move from a low impedance state to a high impedance state in response to the load current approaching the predetermined maximum current.
